(19) United States
(12) Patent Application Publication
(10) Pub. No.: US 2021/0307998 A1
(43) Pub. Date: Oct. 7, 2021

(54) HANDHELD MASSAGE DEVICE

(71) Applicant: EPSILON ELECTRONICS, INC., Montebello, CA (US)

(72) Inventor: Sohail Rochel, Beverly Hills, CA (US)

(21) Appl. No.: 16/926,983

(22) Filed: Jul. 13, 2020

Related U.S. Application Data
(60) Provisional application No. 63/003,818, filed on Apr. 1, 2020.

(51) Int. Cl. A61H 15/00; A61H 23/02

(52) U.S. Cl. CPC A61H 15/0092; A61H 23/0263; A61H 2201/10; A61H 2201/0207; A61H 2201/0153

(57) ABSTRACT

Various embodiments of the present disclosure are directed to a handheld massager having vibrating capabilities. In some embodiments, the handheld massager is adapted to distribute a lubricating liquid onto a massaging tip and/or to deliver energy to tissue in contact with or in close proximity to the handheld massager.

### CROSS-REFERENCE TO RELATED APPLICATIONS

This application claims the benefit of U.S. provisional application No. 63/003,818, filed 1 Apr. 2020, which is hereby incorporated by reference as though fully set forth herein.

### BACKGROUND

### a. Field

The instant disclosure relates to handheld massagers.

### b. Background Art

It is known in the art to provide a handheld massager that vibrates, such as a back massager with a vibrating head.

The foregoing discussion is intended only to illustrate the present field and should not be taken as a disavowal of claim scope.

### BRIEF SUMMARY

Various embodiments of the present disclosure are directed to a handheld massager having vibrating capabilities. In some embodiments, the handheld massager is adapted to distribute a lubricating liquid onto a massaging tip and/or to deliver energy to biological tissue in contact with the massager.

One embodiment of the present disclosure is directed to handheld massager including a lower handle, an upper handle, an articulating head, and a massaging tip. The lower handle having a curved shape, and including a proximal end and a distal end. The upper handle also having a curved shape, and including a proximal end and a distal end. The articulating head positioned between the distal end of the lower handle and the distal end of the upper handle, and the massaging tip extending from the articulating head. The articulating head adjusts an angle of the massaging tip relative to the lower and upper handles. In more specific embodiments, the articulating head maintains the relative angle of the massaging tip relative to the lower and upper handles, and the articulating head includes an articulating head release to temporarily allow adjustment of the relative angle of the massaging tip relative to the lower and upper handles.

Some embodiments of the present disclosure are directed to a handheld massager including a first massaging mechanism, a second massaging mechanism, and a heating element.

Another embodiment of the present disclosure is directed to a massaging tip of a massager including an oil reservoir, and an oil dispensing aperture. In more specific embodiments, the oil reservoir, in response to compression of the massaging tip, excretes oil through the oil dispensing aperture.

The foregoing and other aspects, features, details, utilities, and advantages of the present disclosure will be apparent from reading the following description and claims, and from reviewing the accompanying drawings.

### BRIEF DESCRIPTION OF THE DRAWINGS

Various example embodiments may be more completely understood in consideration of the following detailed description in connection with the accompanying drawings, in which:

FIG. 1A is an perspective left-side view of a handheld massager, consistent with various embodiments of the present disclosure;

FIG. 1B is a perspective right-side view of the handheld massager of FIG. 1A including a partial cross-section of the massager to show internal components, consistent with various embodiments of the present disclosure;

FIG. 1C is a partial, cross-sectional left-side view of the handheld massager of FIG. 1A, consistent with various embodiments of the present disclosure;

FIG. 1D is a partial, cross-sectional left-side view of the handheld massager of FIG. 1A, consistent with various embodiments of the present disclosure;

FIG. 2A is an isometric left-side view of a handheld massager, consistent with various embodiments of the present disclosure;

FIG. 2B is a cross-sectional view of a massaging tip of the handheld massager of FIG. 2A at rest, consistent with various embodiments of the present disclosure;

FIG. 2C is a cross-sectional view of a massaging tip of the handheld massager of FIG. 2A in compression, consistent with various embodiments of the present disclosure; and

FIG. 3 is a perspective side view of an oil injector for filing an oil reservoir within a massaging tip of a handheld massager, consistent with various embodiments of the present disclosure.

While various embodiments discussed herein are amenable to modifications and alternative forms, aspects thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the disclosure including aspects defined in the claims. In addition, the term “example” as used throughout this application is only by way of illustration, and not limitation.

### DETAILED DESCRIPTION OF EMBODIMENTS

The mechanical massage of skin, such as by handheld massagers, is known to affect dermal and subcutaneous connective tissue, promoting blood flow, relieving sore muscles and tension, and stimulating the release of harmful toxins in the skin. Handheld massagers may further enhance microcirculation and promote thicker more hydrated subcutaneous tissue.

Various embodiments of the present disclosure are directed to the combination of mechanical massage via handheld massagers in combination with infrared phototherapy to treat tissue. While light therapy may be for sterilization, pain relief, and photo-rejuvenation; various preferred embodiments of infrared phototherapy presented herein warm the tissue to improve mechanical massage results of the handheld massager. Additional benefits to phototherapy may also include wound healing, cellulite reduction, skin rejuvenation, pain relief, etc.

Mechanical massage, also commonly referred to as percussive massage and tapotement, is the rapid, percussive tapping, slapping and cupping of an area of the human body. Mechanical massage is used to work and strengthen deep-tissue muscles. As discussed above mechanical massage increases local blood circulation and may help tone muscle areas.

Mechanical massage, consistent with various embodiments of the present disclosure, is applied by an electric motor that drives a reciprocating piston within a cylinder. A variety of massaging tips may be attached to the piston to provide different massage effects on selected areas of the body.

Details of the various embodiments of the present disclosure are described below with specific reference to the figures.

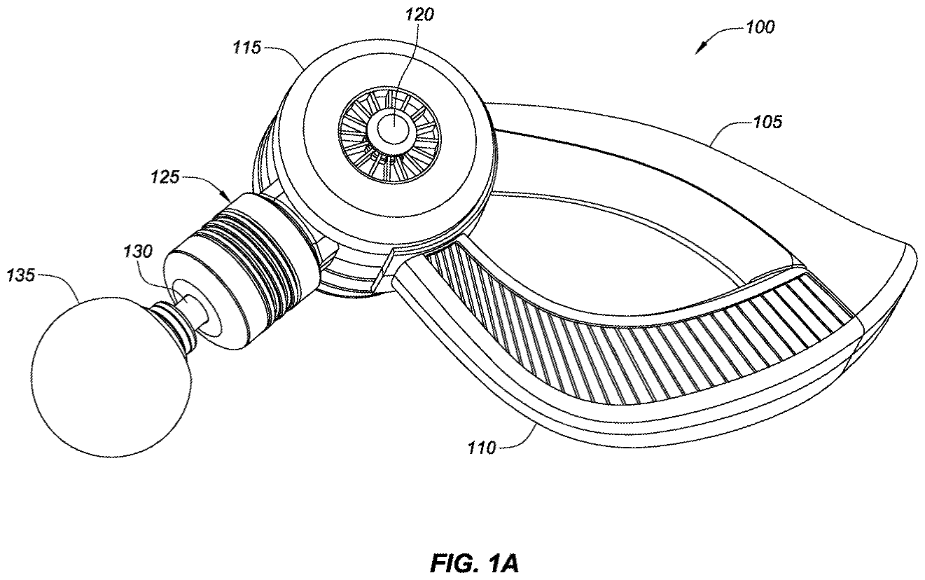

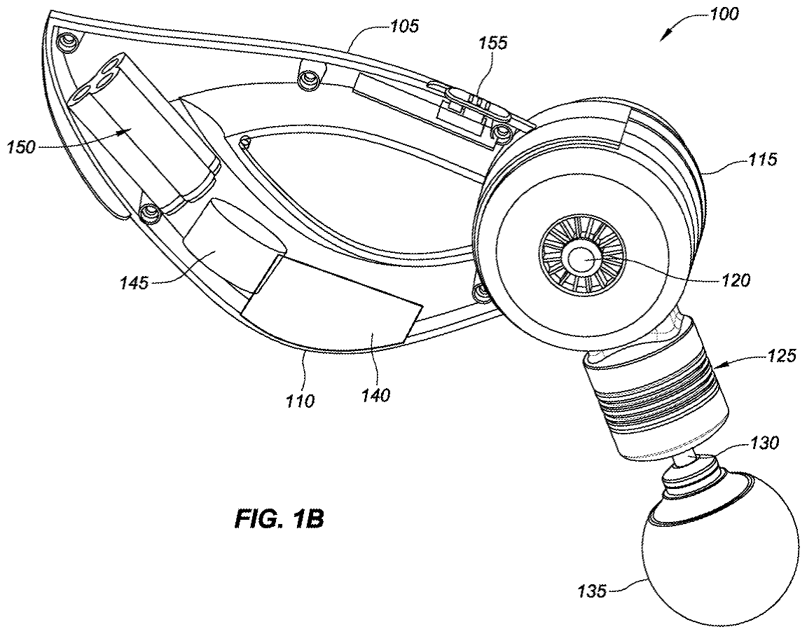

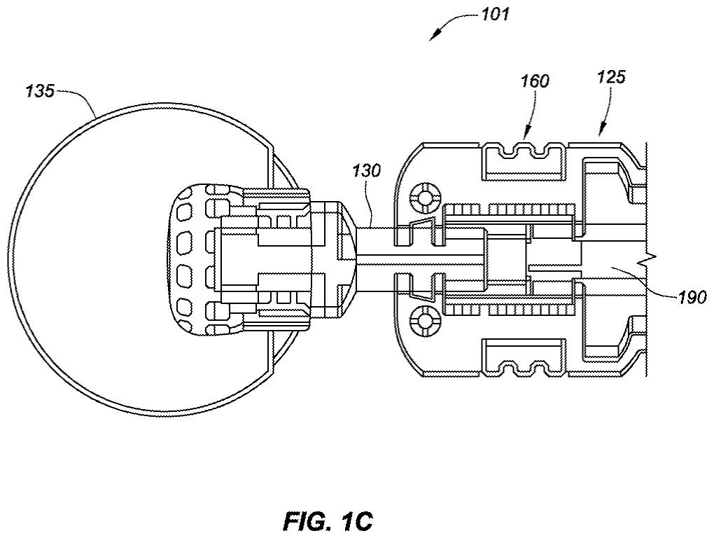

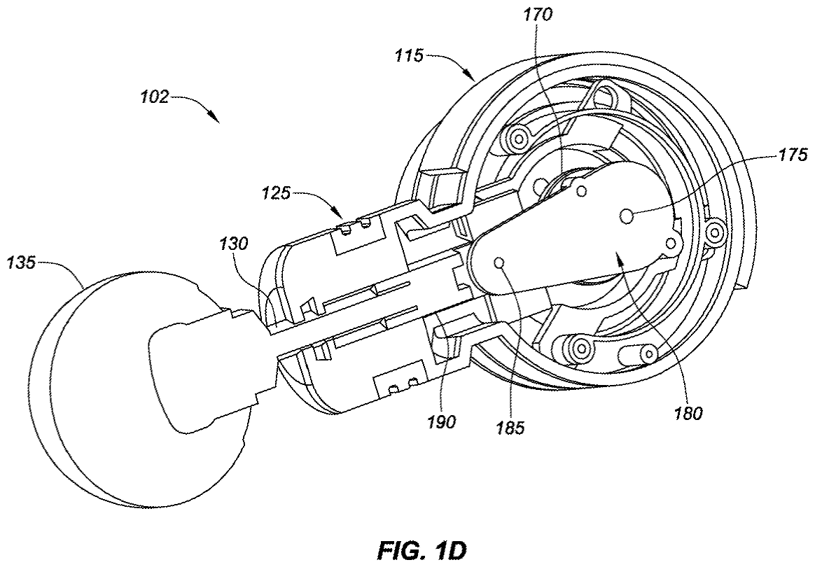

FIG. 1A is an isometric left-side view of a handheld massager 100 and FIG. 1B is a isometric right-side view of the handheld massager of FIG. 1A including a partial cross-section of the massager to show internal components, consistent with various embodiments of the present disclosure. The handheld massager 100 includes an upper handle 105, lower handle 110, and articulating head 115. The articulating head 115 is rotatable relative to the upper and lower handles in response to actuation of articulating head release 120. By articulating the head 115, a user may adjust the angle of a massaging tip 135 relative to the handles. One particular benefit of the articulating head 115 is that a user may rotate a massaging tip 135 relative to the handles 105/110 so that a user may conduct a back massage on themselves.

The articulating head 115 houses an electrical motor and massaging tip drive assembly which drives the massaging tip 135 via vibrating arm 125 and shaft 130.

As shown in FIG. 1B, a power switch 155 for the massager is integrated into upper handle 105. Lower handle 110 includes an infrared heater 140 and a vibration generator 145. A power supply 150 for wireless operation of the handheld massager 100 is located at a juncture between the upper and lower handles. In some embodiments of the present disclosure, the power supply 150 may be removable (e.g., for recharging), and in other embodiments the power supply may be permanently affixed within the massager 100—with recharging of the massager 100 being achieved by transmitting power to the power supply via a charge port.

The handheld massager 100 of FIGS. 1A and 1B may be operated in two or more configurations. In a first configuration, massaging tip 135 may be placed into contact with a user's tissue and actuated to mechanically massage the tissue. In the first configuration, an infrared heater 140 on the handheld massager 100 may be activated to apply radiant heat on to the massaging tip 135 and/or the user's tissue. In a second configuration, lower handle 110 may be placed into contact with the user's tissue and the infrared heater 140 may be activated to apply heat therapy (or phototherapy) to the tissue, and/or a vibration generator 145 may be activated to massage the tissue. A combination of the heat and massage via the lower handle 110 may enhance blood flow in the target tissue of the user. In many embodiments, the mechanical massage of the lower handle 110 and that of the massaging tip 135 may be of differing severity, frequency, or intent. For example, the massaging tip 135 may be used for deep tissue massage of muscles, whereas the lower handle conducts a softer mechanical massage of sensitive regions. In a third configuration of the handheld massager 100, the massaging tip 135 may be rotated via articulating head 115 to facilitate simultaneous tissue contact by both the massaging tip 135 and the lower handle 110. The massager may be run along a user's skin with the tissue first receiving, for example, heat and a light massage from the lower handle 110 before a deep-tissue massage via the massaging tip 135 (or vice versa).

FIG. 1C is a partial, cross-sectional left-side view of the handheld massager 100 of FIG. 1A, consistent with various embodiments of the present disclosure. Particularly, FIG. 1C illustrates a partial drive assembly 101 of the massager. When activated, a rotational motion from an electric motor is translated into a linear motion by a crank and transmitted via a piston 190. The piston is coupled to a shaft 130 which extends out from a vibrating arm 125 and is coupled to massaging tip 135. During actuation of the massaging tip 135, the mass of the massaging tip 135 and shaft 130 create significant vibration due to the recoil associated with the sudden change in direction. During use of the massager 100, the massager recoil may cause fatigue on the user's hands and/or arms. Accordingly, various aspects of the present disclosure are directed to reducing vibration asserted on the user. To that end, handheld massagers disclosed herein may utilize a rubber sleeve 160 inserted into an outer diameter of the vibrating arm 125. The rubber sleeve 160 absorbs at least a portion of the vibration which would otherwise be transmitted from the drive assembly 101 into the handles of the massager. In some specific embodiments consistent with the present disclosure, rubber sleeve 160 of the vibrating arm 125 may consist of one or more of the following: silicone, a thermoplastic elastomer, and an ethylene propylene diene monomer,

FIG. 1D is a partial, cross-sectional left-side view of the handheld massager 100 of FIG. 1A, consistent with various embodiments of the present disclosure. Particularly, FIG. 1D illustrates drive assembly 102 of the massager. The drive assembly 102 including an electric motor 170, a rotatable shaft 175, a crank 180, a reciprocating linkage 185, a piston 190 and a shaft 130. The electric motor 170, in response to actuation of power switch 155 (as shown in FIG. 1B) by the user, receives a drive signal which rotates a rotor relative to a stator of the electric motor. The rotor of the electric motor includes, or is coupled to, the rotatable shaft 175. The rotatable shaft 175 is coupled to a crank 150 which translates the rotational motion of the rotatable shaft 175 in to a linear motion at the reciprocating linkage 185. The reciprocating linkage 185 is coupled to piston 190 and effectuates a reciprocating linear motion of the piston 190 within a vibrating arm 125. The linear motion of the piston 190 is passed on to the shaft 130 (integrated therein or coupled thereto) and ultimately to the massaging tip 135. The reciprocating linear motion of the massaging tip 135 when placed into contact with a user's skin delivers a mechanical massage.

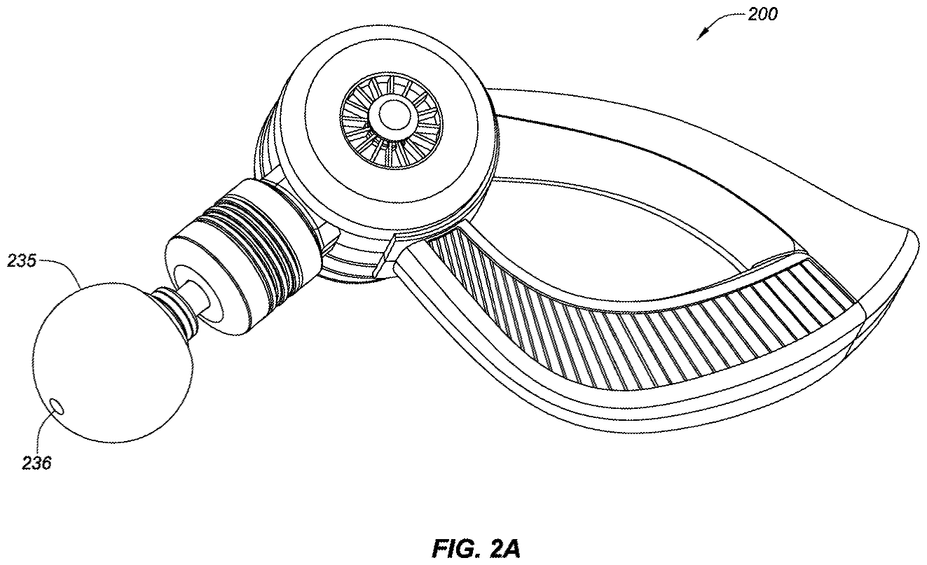

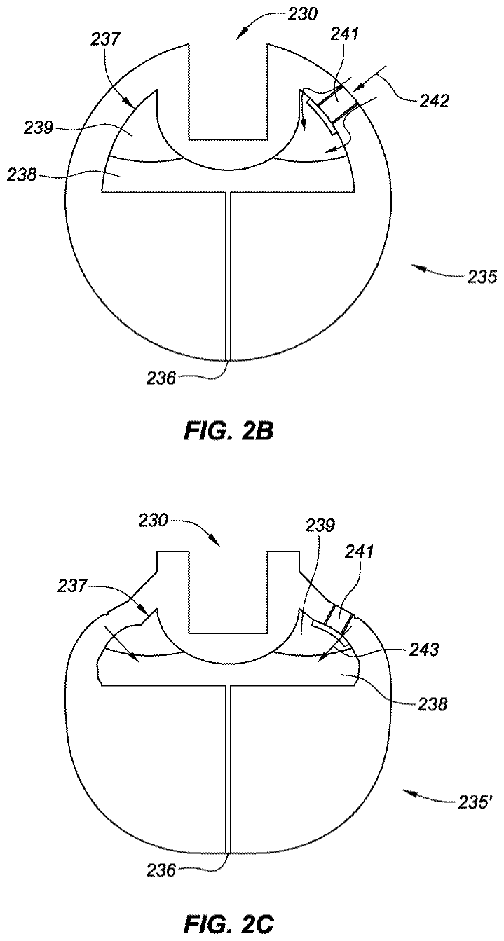

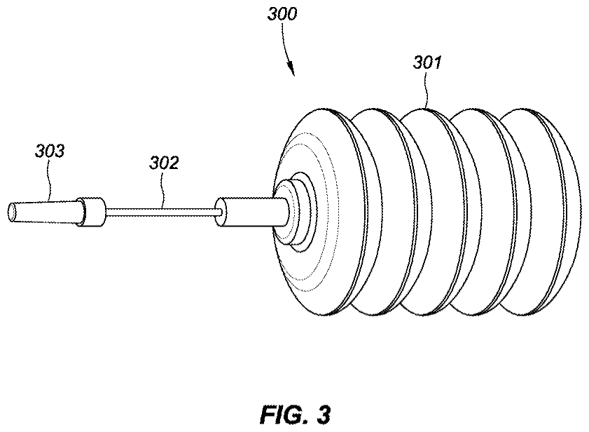

FIG. 2A is an isometric left-side view of a handheld massager 200, consistent with various embodiments of the present disclosure. Aspects of the present disclosure are directed to the use of an oil dispenser within a massaging tip 235 of the massager. The oil may be used to lubricate a surface of the user's skin in contact with the massaging tip to reduce friction and promote deeper muscle contact. While the present embodiment illustrates the massaging tip 235 including an oil dispenser aperture 236 at a distal most end of the massaging tip, a skilled artisan will readily appreciate that various other aperture configurations may be utilized (consistent with the present disclosure). For example, one or more apertures may be utilized to facilitate improved distribution of the oil about the massaging tip. In one such embodiment, a plurality of oil dispenser apertures may be positioned about the massaging tip, such as a crown circumferentially extending about a distal most end of the massaging tip. Each of these oil dispenser apertures may utilize the same oil reservoir or have dedicated oil reservoirs for each aperture.

FIG. 2B is a cross-sectional view of a massaging tip 235 of the handheld massager of FIG. 2A at rest, consistent with various embodiments of the present disclosure. As shown in FIG. 2A, the massaging tip 235 includes a shaft insert 230 to receive and couple thereto a shaft of a drive assembly. The massaging tip 235 further includes an oil reservoir 237 that automatically dispenses oil on to a distal most end of the massaging tip 235 when the massaging tip cycles between a compressed and uncompressed shape as it massages a user's skin.

The oil reservoir 237 may be filled with oil 238 between massages via an oil filler stop 241. The flow of oil 242 during a filling procedure is illustrated in FIG. 2B. An oil injector (as illustrated in FIG. 3) may actuate the oil filler stop 241 inward into the oil reservoir 237 to facilitate the flow of oil 242 around the oil filler stop 241 and into the oil reservoir. Once the oil injector is retracted away from the oil filler stop, the oil filler stop seals to prevent leakage of oil from within the oil reservoir and the escape of air 239.

At any given time, the oil reservoir 237 may be filled with a portion of air 239 and a portion of oil 238. During a compression of the oil reservoir 237 (as shown in FIG. 2C, and discussed in more detail below), a pressure within the reservoir builds as the volume of the reservoir decreases. As the oil filler stop 241 only facilitates one-way flow into the reservoir, some of the oil 238 within the reservoir flows out of the reservoir via the oil dispenser aperture 236 and onto a distal surface of the massaging tip 235.

When the massaging tip 235 decompresses, as shown in FIG. 2B, the oil filler stop 241 allows for a one-way flow of air into the oil reservoir 237 to return the reservoir to an equilibrium pressure with the external atmosphere. Such a pressure equalization would be in response to an earlier compression which evacuated a portion of the oil 238 via the oil dispenser aperture 236. As the massaging tip decompresses, less oil is within the oil reservoir which results in a vacuum pressure state corrected by the flow 242 of air 239 into the oil reservoir 237 via the oil filler stop 241.

While the illustrated embodiment of the massaging tip 235 depicts the oil reservoir 237 within a proximal portion of the massaging tip, various other locations within the massaging tip are readily envisioned. For example, the oil reservoir may be positioned within a distal portion of the massaging tip to shorten a length of the oil dispenser aperture 236. In yet other embodiments, to mitigate the number of oil filings required for a given number of massages, the oil reservoir 237 may comprise a large majority of an internal volume of the massaging tip 235. In such an embodiment, due to the decreased structure of the massaging tip, the material of which the massaging tip comprises may be of a harder durometer to effect deep tissue massage.

FIG. 2C is a cross-sectional view of a massaging tip 235′ of the handheld massager of FIG. 2A in compression, consistent with various embodiments of the present disclosure. When placed in compression, an internal pressure within an oil reservoir 237 prevents oil filler stop 241 from allowing air to enter the reservoir. As a result, compression of the massaging tip 235′ decreases the volume of the oil reservoir 237 resulting in a build-up of pressure 243 therein. Once the pressure 243 within the oil reservoir 237 exceeds a threshold, a portion of the oil 238 will exit the reservoir via oil dispenser aperture 236 and be distributed onto an exterior surface of the massaging tip 235′.

In various embodiments consistent with the present disclosure, oil within the oil reservoir 237 may be heated and/or cooled either passively and/or actively. For example, an electrical heater may be placed within the oil reservoir 237 or in close proximity (e.g., within the massaging tip 235). The electrical heater may be electrically coupled to a power supply within the massager and activated when a user actuates a power switch of the massager. In other embodiments, the oil within the oil reservoir may be passively heated by the dissipation of friction (caused by repeated compression of the massaging tip during use) as heat. In another embodiment, the oil within the oil reservoir may be passively cooled by a flow of air into the oil reservoir in response to a vacuum created when oil within the oil reservoir exits an oil dispenser aperture 236.

FIG. 3 is a perspective side view of an oil injector 300 for filing an oil reservoir within a massaging tip of a handheld massager, consistent with various embodiments of the present disclosure. Prior to use, a cap 303 of the oil injector 300 may be removed. An injecting needle 302 may be inserted into an oil filler stop 241 of a massaging tip 235 (as shown in FIG. 2B). Actuation of the oil filler stop and compression of a collapsing reservoir 301 of the oil injector facilitates transfer of oil from within the collapsing reservoir, through the injecting needle 302 and oil filler stop 241, and into an oil reservoir 237 within the massaging tip (as shown in FIG. 2B).

Although several embodiments have been described above with a certain degree of particularity, those skilled in the art could make numerous alterations to the disclosed embodiments without departing from the spirit of the present disclosure. It is intended that all matter contained in the above description or shown in the accompanying drawings shall be interpreted as illustrative only and not limiting. Changes in detail or structure may be made without departing from the present teachings. The foregoing description and following claims are intended to cover all such modifications and variations.

Various embodiments are described herein of various apparatuses, systems, and methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” “an embodiment,” or the like, means that a particular feature, structure, or characteristic described in connection with the embodiment is included in at least one embodiment. Thus, appearances of the phrases “in various embodiments,” “in some embodiments,” “in one embodiment,” “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. A handheld massager comprising:
a lower handle having a curved shape, the lower handle including a proximal end and a distal end;
an upper handle having a curved shape, the upper handle including a proximal end and a distal end;
an articulating head positioned between the distal end of the lower handle and the distal end of the upper handle; and
a massaging tip extending from the articulating head;
wherein the articulating head is configured and arranged to adjust an angle of the massaging tip relative to the lower and upper handles.

2. The handheld massager of claim 1, the articulating head is further configured and arranged to maintain the relative angle of the massaging tip relative to the lower and upper handles, the articulating head including an articulating head release configured and arranged to temporarily allow adjustment of the relative angle of the massaging tip relative to the lower and upper handles.

3. The handheld massager of claim 1, further including
a drive assembly configured and arranged to actuate the massaging tip, and
a second massaging mechanism within one of the lower handle and the upper handle, the second massaging mechanism configured and arranged to massage tissue when placed into contact with the tissue.

4. The handheld massager of claim 3, further including a heating element positioned adjacent to the second massaging mechanism.

5. The handheld massager of claim 3, further including a heating element within one of the lower handle and the upper handle.

6. The handheld massager of claim 1, the massaging tip including a heating element configured and arranged to warm the massaging tip.

7. The handheld massager of claim 1, the massaging tip including an oil reservoir configured and arranged to excrete oil on to a distal tip portion of the massaging tip from within the oil reservoir in response to contact between the massaging tip and a user's tissue.

8. The handheld massager of claim 7, the massaging tip including a heating element configured and arranged to warm the oil within the oil reservoir.

9. The handheld massager of claim 1, wherein the articulating head includes a vibrating arm containing at least a portion of a first massaging mechanism, the vibrating arm including a rubber sleeve which circumferentially extends around and into an outer diameter of the vibrating arm, the rubber sleeve configured and arranged to absorb vibration associated with actuation of the massaging tip.

10. A handheld massager comprising:
a first massaging mechanism;
a second massaging mechanism; and
a heating element.

11. The handheld massager of claim 10, further including
a lower handle having a curved shape, the lower handle including a proximal end and a distal end;
an upper handle having a curved shape, the upper handle including a proximal end and a distal end;
an articulating head positioned between the distal end of the lower handle and the distal end of the upper handle; and
a massaging tip extending from the articulating head;
wherein the first massaging mechanism is configured and arranged to actuate the massaging tip;
wherein the second massaging mechanism is positioned within one of the lower handle and the upper handle, the second massaging mechanism configured and arranged to massage tissue when the handle is placed into contact with the tissue.

12. The handheld massager of claim 10, further including a handle, the heating element positioned within the handle.

13. The handheld massager of claim 11, wherein the heating element is positioned within the massaging tip and is configured and arranged to warm the massaging tip.

14. The handheld massager of claim 10, wherein the first massaging mechanism includes a massaging tip with an oil reservoir configured and arranged to excrete oil on to a distal portion of the massaging tip in response to contact between the massaging tip and a user's tissue.

15. The handheld massager of claim 14, wherein the first massaging mechanism further includes a second heating element configured and arranged to warm the oil within the oil reservoir.

16. A massaging tip of a massager comprising:
an oil reservoir; and
an oil dispensing aperture.

17. The massaging tip of claim 16, wherein the oil reservoir is configured and arranged in response to compression of the massaging tip to excrete oil through the oil dispensing aperture.

18. The massaging tip of claim 16, further including an oil filler stop configured and arranged to facilitate filing the oil reservoir with oil by functioning as a one-way valve that allows oil into the oil reservoir but prevents the escape of air from within the oil reservoir through the oil filler stop in response to a compression of the massaging tip.

19. The massaging tip of claim 16, wherein the oil dispensing aperture is configured and arranged to excrete oil on a distal portion of the massaging tip.

20. The massaging tip of claim 16, wherein the oil dispensing aperture includes a plurality of oil dispensing apertures which are configured and arranged to distribute oil from the oil reservoir evenly across a distal portion of the massaging tip.
